(19) United States
(12) Patent Application Publication
(10) Pub. No.: US 2016/0278069 A1
(43) Pub. Date: Sep. 22, 2016

(54) METHOD AND APPARATUS FOR APPLICATION RECOGNITION QOS-DIFFERENTIATED DEVICE-TO-DEVICE COMMUNICATION IN WIRELESS COMMUNICATION SYSTEM

(71) Applicant: SAMSUNG ELECTRONICS CO., LTD, Suwon-si, Gyeonggi-do (KR)

(72) Inventors: Sungjin LEE, Bucheon-si (KR); Youngbin CHANG, Anyang-si (KR); Seunghoon PARK, Seoul (KR); Kyungkyu KIM, Suwon-si (KR); Sangkyu BAEK, Suwon-si (KR)

(21) Appl. No.: 15/036,621

(22) PCT Filed: Nov. 29, 2013
(86) PCT No.: PCT/KR2014/011497

§ 371 Date: May 13, 2016

(30) Foreign Application Priority Data
Nov. 29, 2013 (KR) 10-2013-0146868

(51) Int. Cl. H04W 72/04; H04W 8/00; H04W 76/04

(52) U.S. Cl. CPC H04W 72/048; H04W 76/043; H04W 8/005

(57) ABSTRACT

The present invention relates to a device-to-device (D2D) communication method and an apparatus therefor. A device-to-device communication method according to an embodiment of the present invention may comprise the steps of: transmitting, to a base station, a device-to-device communication registration request message including identification information and interest information of a device-to-device communication service; receiving, from the base station, a device-to-device communication registration response message including device-to-device communication resource information which has been allocated according to the identification information of the device-to-device communication service; and transmitting a device-to-device communication signal using the allocated device-to-device communication resource. According to an embodiment of the present invention, it is possible to ensure a QoS differentiated according to the service of an application which is used by various users, perform a device-to-device communication process which is independent of a data communication, and conduct interference management under simultaneous connection with a cellular user.

### TECHNICAL FIELD

The present invention relates to a device-to-device (D2D) communication method and apparatus. In detail, the present invention relates to a method and apparatus for supporting QoS in the D2D communication service.

### BACKGROUND ART

With the advance of mobile communication technology, a new type of mobile communication has emerged called device-to-device (D2D) communication, which has a different nature from legacy base station-based mobile communication. In addition to the legacy Bluetooth-based and WLAN-based services, the 3GPP as one of the main standardization organizations has started standardization work for D2D communication over LTE for which various contributions have been made. One of the main aspects of D2D communications is a discovery service, which is expected to be used for various applications and services in the future.

In spite of expectations that the discovery service would be important, studies on supporting Quality of Service (QoS) for the discovery service have not been conducted actively yet. As a consequence, most of the related technologies are being studied with QoS for data communication but with no definition on any QoS for discovery service.

In the legacy D2D communication technologies, studies have been directed at how to support QoS for data communication. According to the studies, it is possible to minimize interference between users using a spectrum underlay scheme for use of cellular uplink spectrum.

However, the conventional methods have a drawback in that the QoS is guaranteed for data communications; thus, the discovery technology depends on the data communication.

Meanwhile, consideration may be given to allocating Orthogonal Frequency Division Multiple Access (OFDMA) tones of independently allocated frequency band in a distributed fashion so as to cancel the interference between the discovery service and legacy cellular communication.

However, this method is also not a discovery technology specific to user, application, and/or service. This method may also have a problem in being applied to the real system because the problem is addressed under an ideal assumption that the resources are allocated independently from cellular communication.

### DISCLOSURE OF INVENTION

### Technical Problem

The present invention aims to overcome the drawbacks of conventional technologies such as data communication-dedicated QoS support, data communication-dependent discovery procedure, non-service required QoS distinctive discovery technology, and non-real assumption of legacy cellular resource-independent frequency allocation.

For this purpose, the present invention proposes a discovery procedure that is capable of guaranteeing service-specific QoS for applications used by diverse users and is independent from data communication and a technology designed in consideration of interference management in an environment where cellular users and D2D users coexist.

Also, the present invention aims to provide a method and apparatus for securing data rate in order to guarantee application service-specific QoSs even in a restricted environment where the D2D communication service uses the same frequency band as legacy cellular communication. In order to achieve this object, the present invention provides a frequency resource allocation method and apparatus that are capable of minimizing inter-cell interference based on neighboring cell frequency allocation information received through an X2 interface or related resource allocation information from an MME. The present invention provides a spatial reuse maximization method and apparatus that are capable of maximizing diversity gain in time, frequency, and antenna domains without, as far as possible, interference between users within the same cell. The present invention aims to propose a network signaling procedure for implementing the above two methods in a network and provide a method and apparatus for categorizing the procedure in an application service scenario-specific manner

Also, the present invention aims to provide various methods and apparatuses for supporting QoS in the D2D discovery service in cooperation among network entities such as a User Equipment (UE), an evolved Node B (eNB) connected to the UE, a Serving-Gateway (S-GW), and a Mobility Management Entity (MME).

The objects of the present invention are not limited to the aforesaid, and other objects not described herein with be clearly understood by those skilled in the art from the descriptions below.

### Solution to Problem

In accordance with an aspect of the present invention, a device-to-device communication method of a terminal includes transmitting a device-to-device communication registration request message including device-to-device communication service identity information and interest information to a base station, receiving a device-to-device communication registration response message including allocated device-to-device communication resource information from the base station according to the device-to-device communication service identity information, and transmitting a device-to-device communication signal using allocated device-to-device communication resources.

Preferably, the device-to-device communication service is a discovery service, and the device-to-device communication service identity information is determined based on at least one of discovery service enabled distance, energy saving mode availability, energy saving degree of the energy saving mode, discovery specification openness (valid member), discovery end condition (valid time), application identity information, and interest information.

Preferably, transmitting the device-to-device communication registration request message includes determining device-to-device communication class based on the device-to-device communication identity information and transmitting the device-to-device communication registration request message including the device-to-device communication class and the interest information to the base station.

Preferably, the allocated device-to-device communication resource information includes at least one of a number and positions of tones, power value, a number and positions of antennas, and a number and positions of time slots.

Preferably, the device-to-device communication method further includes stopping transmitting the discovery signal when a response message is received from a receiving terminal which received the discovery signal.

In accordance with another aspect of the present invention, a communication method of a base station includes receiving a device-to-device communication registration request message including device-to-device communication service identity information and interest information from a terminal, allocating device-to-device communication resources according to the device-to-device communication service identity information, and transmitting a device-to-device communication registration response message including allocated device-to-device communication resource information to the terminal.

Preferably, allocating the device-to-device communication resources includes receiving neighbor base station resource allocation information from a neighbor base station (eNB) or a higher level network entity and allocating the device-to-device communication resources according to the neighbor base station resource allocation information and the device-to-device communication identity information.

Preferably, allocating the device-to-device communication resources includes determining a device-to-device communication class based on the device-to-device communication service identity information and a target QoS value according to the device-to-device communication class and allocating the device-to-device communication resource based on the target QoS value.

In accordance with another aspect of the present invention, a terminal supporting device-to-device communication includes a communication unit which performs device-to-device communication with another terminal and a base station and a control unit which controls transmitting a device-to-device communication registration request message including device-to-device communication service identity information and interest information to a base station, receiving a device-to-device communication registration response message including allocated device-to-device communication resource information from the base station according to the device-to-device communication service identity information, and transmitting a device-to-device communication signal using allocated device-to-device communication resources.

In accordance with still another aspect of the present invention, a base station includes a communication unit which communicates with a terminal and another network entity and a control unit which controls receiving a device-to-device communication registration request message including device-to-device communication service identity information and interest information from a terminal, allocating device-to-device communication resources according to the device-to-device communication service identity information, and transmitting a device-to-device communication registration response message including allocated device-to-device communication resource information to the terminal.

### Advantageous Effects of Invention

The D2D communication method and apparatus of the present invention is advantageous in terms of guaranteeing user application service specific QoSs and performing D2D communication independent from data communication and interference management even when D2D and cellular users are connected to the network simultaneously.

Also, the D2D communication method and apparatus of the present invention is advantageous in terms of guaranteeing QoS in a user application service-specific manner even in a restricted environment where the D2D service shares the same frequency band as legacy cellular communication.

The advantages of the present invention are not limited to the aforesaid, and other advantages not described herein will be clearly understood by those skilled in the art from the descriptions below.

### BRIEF DESCRIPTION OF DRAWINGS

FIG. 1 is a diagram illustrating exemplary discovery resource allocation conditions for respective discovery classes according to an embodiment of the present invention;

FIG. 2 is a diagram illustrating a discovery resource allocation operation according to an embodiment of the present invention;

FIG. 3 is a diagram illustrating a discovery resource allocation procedure according to an embodiment of the present invention;

FIG. 4 is a signal flow diagram illustrating a discovery procedure according to an embodiment of the present invention;

FIG. 5 is a signal flow diagram illustrating a discovery procedure according to another embodiment of the present invention;

FIG. 6 is a signal flow diagram illustrating a discovery procedure according to another embodiment of the present invention;

FIG. 7 is a block diagram illustrating a configuration of the UE according to an embodiment of the present invention; and

FIG. 8 is a block diagram illustrating a configuration of the eNB according to an embodiment of the present invention.

### MODE FOR THE INVENTION

Exemplary embodiments of the present invention are described in detail with reference to the accompanying drawings.

Detailed descriptions of well-known functions and structures incorporated herein may be omitted to avoid obscuring the subject matter of the present invention. This aims to omit unnecessary description so as to make clear the subject matter of the present invention.

Detailed descriptions of well-known functions and structures incorporated herein may be omitted to avoid obscuring the subject matter of the present invention. Exemplary embodiments of the present invention are described in detail with reference to the accompanying drawings. Further, the following terms are defined in consideration of the functionality in the present invention, and they may vary according to the intention of a user or an operator, usage, etc. Therefore, the definition should be made on the basis of the overall content of the present specification.

Meanwhile, the embodiments of the present invention may be applied to D2D communications. In the embodiments of the present invention, D2D communication data may include a format of data coming from an application, e.g., discovery, voice, video, text, web, and File Transfer Protocol (FTP) formats. Although the description is directed to the discovery technology format for explanatory convenience, the present invention can be applied to any of all D2D data formats.

According to an embodiment of the present invention, the D2D application-aware discovery technology may consist of three phases.

First, it may be possible to determine a discovery class for the application support service and target QoS corresponding thereto and register and authenticate the QoS and corresponding user's interest with a network.

Next, it may be possible for the serving eNB to acquire neighbor cell resource allocation information from neighbor cells or a higher network entity. The serving eNB may allocate discovery resources in response to a discovery QoS request of the corresponding user based on the neighbor eNB resource allocation information and transmit the discovery resource allocation information to the user.

Finally, it may be possible to perform the application service-aware discovery operation using the allocated discovery resources.

A description is made hereinafter of the D2D discovery operation according to an embodiment of the present invention with reference to the accompanying drawings.

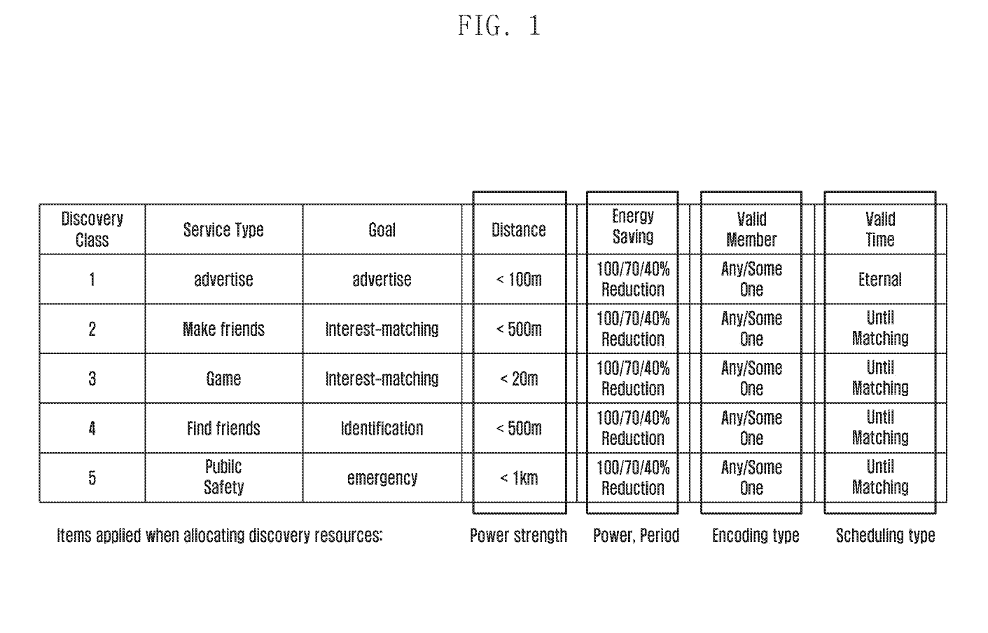

FIG. 1 is a diagram illustrating exemplary discovery resource allocation conditions for respective discovery classes according to an embodiment of the present invention.

According to an embodiment of the present invention, it may be possible to configure a discovery class per application support service for the D2D application-aware discovery technology as described above. It may also be possible to acquire a target QoS value according to the configured discovery class.

Referring to FIG. 1, the QoS value configured according to the discovery class may change depending on the application service type. For example, the application service type may be determined differently depending on service-enabled distance, whether an energy saving mode is enabled or not, energy saving degree when the energy saving mode is enabled, whether to open the discovery specification (valid member), discovery end condition (valid time), application (App) identity information, interest information, etc. At this time, the service enabled distance may be associated with transmission power strength, and whether the energy saving mode is enabled or not and energy saving degree may be associated with the transmission power strength and transmission period. Also, whether to open the discovery specification may be associated with an encoding type, and the discovery end condition may be associated with a scheduling type. The interest information may denote the information which a UE wants to transmit or receive through a discovery message. As described above, the discovery class may be determined according to the application service type, and the target QoS value may be determined according to the discovery class. For example, if the discovery application for a D2D service is associated with a commercial advertisement, the service enabled distance may be equal to or less than 100 m. By restricting the service enabled distance to 100 m, it may be possible to expect the effect of advertisement to the receiving UEs within the coverage of the transmitting UE. According to an embodiment, it may be possible to increase or decrease the service enabled distance. Since the advertisement should be checked by a certain receiving UE, it may be possible to configure the encoding type such that the discovery specification is open to all UEs. It may also be possible to continue transmitting the advertisement periodically by not restricting the discovery end condition to the UEs that have already received the advertisement; thus, the advertisement effect is improved with repeated exposure.

A discovery application for the D2D service may be used for private social activity. In this case, the service enabled distance may be configured differently depending on the purpose of the service. For example, it may be possible to set the service enabled distance to 500 m in order for the transmitting UE to check whether a user's friend is located within the range. It may also be possible to set the service enabled distance to 200 m in order for the user to play a game with a friend located nearby. In the case of using a private social activity service, it may also be possible to configure the encoding type such that other UEs cannot check the discovery signal. In this case, the discovery end condition may be set to the UE that has already received the signal because the receipt of a discovery signal transmitted by the transmitting UE can be regarded as achievement of the discovery purpose.

Although the descriptions have been directed to the items applicable for application service type-specific discovery resource allocations, the present invention is not limited thereto. For example, it may be possible to configure such that the discovery signal is transmitted periodically for the case of a private social activity application.

According to an embodiment, it may be possible to designate a service ID (or discovery service identification information) according to the discovery application service. As shown in FIG. 1, examples of the application service may include a commercial advertisement service, a private social activity service for making friends, a game service, a friend finding service, and a public safety service. At this time, a service ID may be designated per service. Afterward, the UE may transmit the service ID of the selected service to an eNB to deliver the target QoS value required for the corresponding service. For this purpose, the UE and eNB may store a list of target QoS values per service ID and, according to an embodiment, the target QoS value list per service may be modified by the user or operator.

According to an embodiment, the service ID may indicate one or more services. For example, the friend-making service and friend-finding service as part of the social activity service have in common that they both require private security and allow transmission of a discovery signal such that the UEs located within a predetermined range may receive the signal. In this case, the same service ID may be designated to the friend-making service and friend-finding service.

Meanwhile, the discovery class and the service ID (or service type) of the corresponding application may be mapped by the user. For example, the user may map an application service ID to a discovery class according a discovery class determination scheme using a menu provided for the application service.

According to an embodiment, the application service IDs and discovery classes may be mapped in advance by the operator or contents provider. In this case, the discovery class of the corresponding application service may be predetermined by the operator or the contents provider; thus, when the UE selects the corresponding service, the eNB or D2D agent may recognize the discovery class automatically.

According to an embodiment, the network may acquire the mapping information between the application service IDs and discovery classes. For example, the network may receive discovery class information corresponding to the service ID of the corresponding application which is predetermined by a third party for use in discovery application service of the corresponding UE. Even though there is a change in the mapping information between the application service IDs and discovery classes which have been configured by the operator or the contents provider, it is possible to receive the changed information from the network.

According to an embodiment, the application service IDs and discovery classes may be mapped through the cooperation between at least two of the users, operators, and contents providers. For example, if an operator has the mapping information between application service IDs and discovery classes, it may be possible to configure such that the discovery class of the corresponding service ID is changed according to a request from a contents provider.

In the case of D2D data communication, however, the QoS value may vary depending on the D2D communication service identification information. For example, the D2D communication service may be identified based on the data formats for discovery signal, voice, video, text, web, and FTP, or based on the application identification information and interest information. In the case of data communication, the interest information may include data type or QoS information. In the case of public safety communication, the information may include group information (e.g. police and firefighter) and per-group priority information.

The following description is directed to the case of using the service ID of the application in the discovery procedure for explanatory convenience. In the following description, the terms “D2D service identification information” and “discovery identification information” are used interchangeably. That is, the service identification information may be applied to both the discovery and data communications.

How to configure the discovery class per discovery application and determine the target QoS value has been described above.

A description is made of the method for allocation resources based on the target QoS value hereinafter.

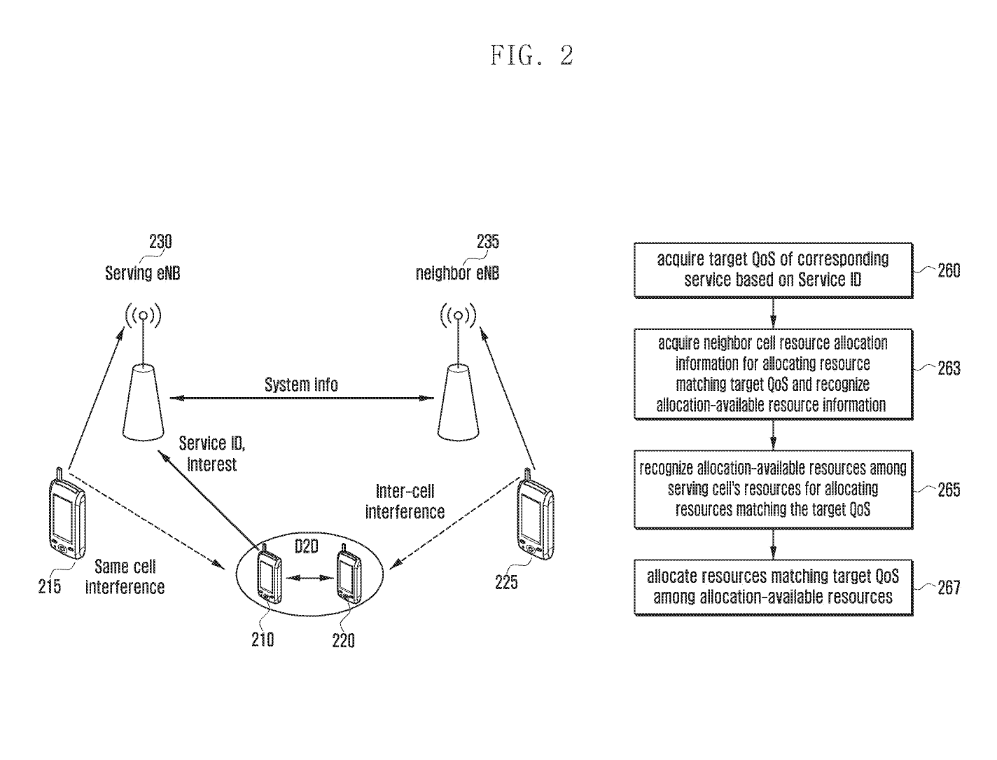

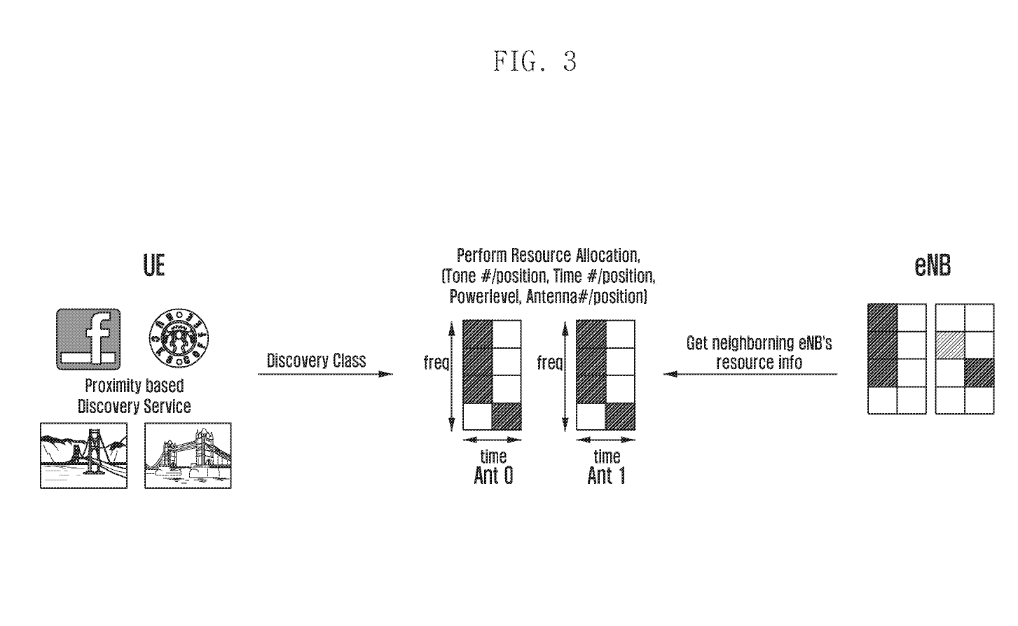

FIG. 2 is a diagram illustrating a discovery resource allocation operation according to an embodiment of the present invention, and FIG. 3 is a diagram illustrating a discovery resource allocation procedure according to an embodiment of the present invention.

Referring to FIG. 2, a first UE (or a transmitting UE) 210 may configure discovery class per application service for D2D application-aware discovery technology as described above at step 260. It may also be possible to acquire a target QoS value according to the configured discovery class of the application service. At this time, the discovery class may be configured by the operator or the contents provider as described above.

That is, the transmitting UE 210 may transmit the service ID of the discovery application service to a serving eNB 230. At this time, the transmitting UE 210 may send the serving eNB 230 an interest in the corresponding service along with the service ID. Then the eNB may acquire the target QoS value required for the discovery class corresponding to the service ID.

The serving eNB 230 may register and authenticate the discovery class and interest corresponding to the target QoS value with the network. This is to avoid QoS violation according to the agreement made between the third party authenticated and registered with the network and the operator. That is, the serving eNB acquires the QoS value predetermined according to the discovery class from the application and registers and authenticates the QoS value and the user's interest with the network. Such a registration and authentication procedure may be performed by at least one of the user (i.e. UE), operator, and contents provider.

The serving eNB 230 may acquire neighbor cell resource allocation information from a neighbor eNB 235 or a high level network entity (not shown) at step 263. The resource allocation information may include the information such as a number and positions of tones, power value, a number and positions of antennas, and a number and positions of time slots.

The serving eNB 230 may check the allocatable discovery resources based on the resource allocation information of the neighbor eNB 235 in response to the discovery application service target QoS request. That is, it may be possible for the serving eNB 230 to check the allocatable resources for canceling inter-cell interference with the neighbor eNB 235.

The serving eNB 230 may check the allocatable resources among the resources it has at step 265 and then allocate the resources suitable for the target QoS at step 267. At this time, the resource allocation is made in such a way of reducing interference with the other UE 215. That is, the serving eNB 230 allocates the discovery resources including the number and positions of tones, power value, the number and positions of antennas, and the number and positions of time slots and transmits the corresponding information to the transmitting UE 210.

Then the transmitting UE 210 may perform the service-aware discovery using the allocated discovery resources.

Although not shown, it is obvious to those skilled in the art that the procedure explained with reference to FIG. 2 can be applied to the above described D2D communication.

The discovery resource allocation method is described in more detail with reference to FIG. 3. Referring to FIG. 3, the serving eNB 230 may allocate discovery resources based on the discovery class acquired from the transmitting UE 210 and the neighbor eNB resource allocation information acquired from the neighbor eNB 235 (or high level network entity).

At this time, the discovery resources may be allocated according to the discovery class as described above. The discovery resource allocation may affect the transmission power strength, transmission period, message encoding type, resource scheduling type, number and positions of tones, number and positions of antennas, number and positions of time slots, number and positions of resource blocks, hopping pattern, etc.

The discovery class may consist of several fields set differently depending on the service type (or service ID) as shown in FIG. 1. These fields may include a service goal, service enabled distance (service distance), energy saving mode applicability and energy saving degree, discovery specification openness (valid member), discovery end condition (valid time), application (App) identity information, and interest fields. The respective fields may be configured when the discovery resources are allocated as described above. For example, the service enabled distance may affect the transmission power strength, and the energy saving mode applicability field may affect the transmission power strength and transmission period.

According to an embodiment, the discovery class may be determined based on at least one of the aforementioned fields.

According to an embodiment, it may be possible to perform inter-cell negotiation with neighbor eNBs for discovery resource allocation based on the service enabled distance during the transmission power configuration procedure so as to cancel the inter-cell interference. In the case that the serving eNB configures the discovery resource information transmission power, it may be possible to transmit the information such that the inter-cell interference is canceled between neighbor eNBs. The serving eNB may send the neighbor eNBs a message requesting for limiting their transmission powers on the resources that may cause interference to the corresponding transmission resources.

According to an embodiment, the discovery resources may be allocated in such a way of reducing the resource allocation amount for energy saving. That is, the transmitting UE may enter an energy saving mode upon detection of its battery condition or receipt of a user request.

In the case of being configured for use in the energy saving mode, the discovery resource may be allocated such that the discovery signal is transmitted at a power strength level reduced as much as a predetermined ratio or amount. According to an embodiment, it may be possible to allocate the discovery resource such that the discovery signal is transmitted at a transmission power level which is configured by the user or designated by a network entity.

According to an embodiment, in the case of being configured for use in the energy saving mode, it may be possible to allocate the discovery resource such that the discovery signal is transmitted at a predetermined transmission period or a period configured by the user.

According to an embodiment, in the case that the serving eNB selects discovery resources, it may exchange resource allocation status information with other eNBs or a high level network entity to allocate the discovery resources.

According to an embodiment, it may be possible to configure the discovery resource allocation procedure such that the discovery signal is transmitted repeatedly until a response signal is receive from a receiving UE or a network entity. For example, if the discovery signal is associated with an advertisement, it may be possible to configure such that the transmitting UE stops transmitting the advertisement signal when a response message corresponding to the discovery signal is received from the receiving UE.

At this time, the response signal from the receiving UE or the network entity may be an acknowledgement of the receipt of the discovery signal transmitted by the transmitting UE. According to an embodiment, the response signal may be defined by positive interest information, negative interest information, or other information. The response signal may also be defined by any combination of those information items. In the case that the transmitting UE transmits a discovery signal for the friend-finding service, the receiving UE may transmit a response signal including the positive interest information when the user of the receiving terminal is the corresponding friend.

According to an embodiment, the response signal may include the information on a user or a plurality of users.

According to an embodiment, if semi-persistent scheduling is configured in allocating resources for discovery signal transmission, the transmitting UE may transmit the discovery signal periodically without additional scheduling control messages.

Although not shown, it is obvious to those skilled in the art that the discovery resource allocation explained with reference to FIG. 3 can be applied to the above described D2D communication.

The target QoS value-based resource allocation method has been described above.

A description is made in detail hereinafter of the service type-based D2D discovery operation.

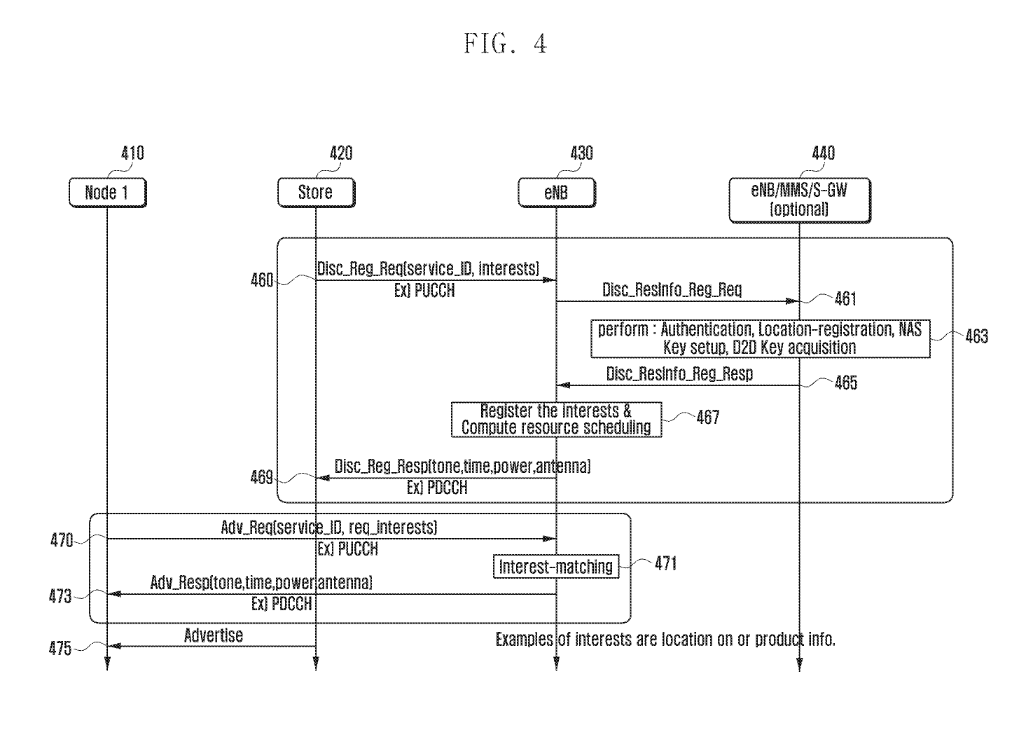

FIG. 4 is a signal flow diagram illustrating a discovery procedure according to an embodiment of the present invention.

The embodiment of FIG. 4 is directed to the case where the D2D discovery service is of a store-matching type such as advertisement.

Referring to FIG. 4, the store (transmitting UE) 420 may send the serving eNB 430 a discovery registration request (Disc_Reg_Req) message at step 460. At this time, the Disc_Reg_Req message transmitted by the serving UE 420 may include a service identifier (service_ID) of the discovery service and interest information of the store. The interest information of the store may include kinds of goods, coupons, discount, and store location information. According to an embodiment, the Disc_Reg_Req message may be transmitted over, but without being limited to, PUCCH.

If the Disc_Reg_Req message is received, the serving eNB 430 may send the MME or a high level gateway (e.g. S-GW) 440 a discover resource information registration request (Disc_ResInfo_Reg_Req) message at step 461. The MME 440 may perform authentication on the information received by the eNB, location registration, NAS key setup, and D2D key acquisition operations.

If the Disc_ResInfo_Reg_Req message is received, the MME 440 may perform discovery resource information registration on the received information at step 463. That is, the MME 440 may perform received information authentication, location registration, NAS key setup, and D2D key acquisition operations.

After registering the discovery resource information, the MME 440 may send the serving eNB 430 a discovery resource information registration response (Disc_ResInfo_Reg_Resp) message at step 465.

Then, although not shown, the serving eNB 430 may receive neighbor eNB resource allocation information from a neighbor eNB. According to an embodiment, the serving eNB 430 may send the neighbor eNB a response message.

The serving eNB 430 may register the interest information of the store and allocate resources in tone, time, power, and antenna domains on the basis of the neighbor eNB resource allocation information. The detailed description thereof has been made above and thus omitted herein.

Then the serving eNB 430 may send the transmitting UE (i.e. the store) 420 a discovery registration response (Dis_Reg_Resp) message including the resource allocation information at step 469. That is, the serving eNB 430 may send the transmitting UE 420 the information on the discovery resource allocated in the tone, time, power, and antenna domains. According to an embodiment, the discovery resource allocation information may be transmitted over, but without being limited to, PDCCH.

Then the receiving UE 410 may send the serving eNB 430 an advertisement request (Adv_Req) message for the corresponding service at step 470. At this time, the Adv_Req message transmitted by the receiving UE 410 may include the information such as the service identifier (service ID) of the service which the receiving UE is interested in and request interests (req_interests). According to an embodiment, the Adv_Req message may be transmitted over, but without being limited to, PUCCH.

If the response message is received at step 470, the serving eNB 430 may compare the registered interest received from the transmitting UE 420 and the requested interest received from the receiving UE 410 at step 471.

The serving eNB 430 may retrieve the information on the transmitting UE 420 which matches the range of the requested interest of the receiving UE 410 and send the receiving UE 410 an advertisement response (Adv_Resp) message at step 473 including the information on the resource allocated to the transmitting UE 420. At this time, the Adv_Resp message may include the information on the discovery resources allocated in the tone, time, power, and antenna domains. According to an embodiment, the Adv_Resp message may be transmitted over, but without being limited to, PDCCH.

Then the receiving UE 410 may receive the advertisement information periodically from the transmitting UE 420 at step 475.

At this time, the transmitting UE 420 may transmit a discovery signal, e.g. advertisement, periodically. According to an embodiment, if the receiving UE 410 transmits a response signal to the transmitting UE 420, the transmitting UE 420 may stop transmitting the discovery signal upon receipt of the response signal.

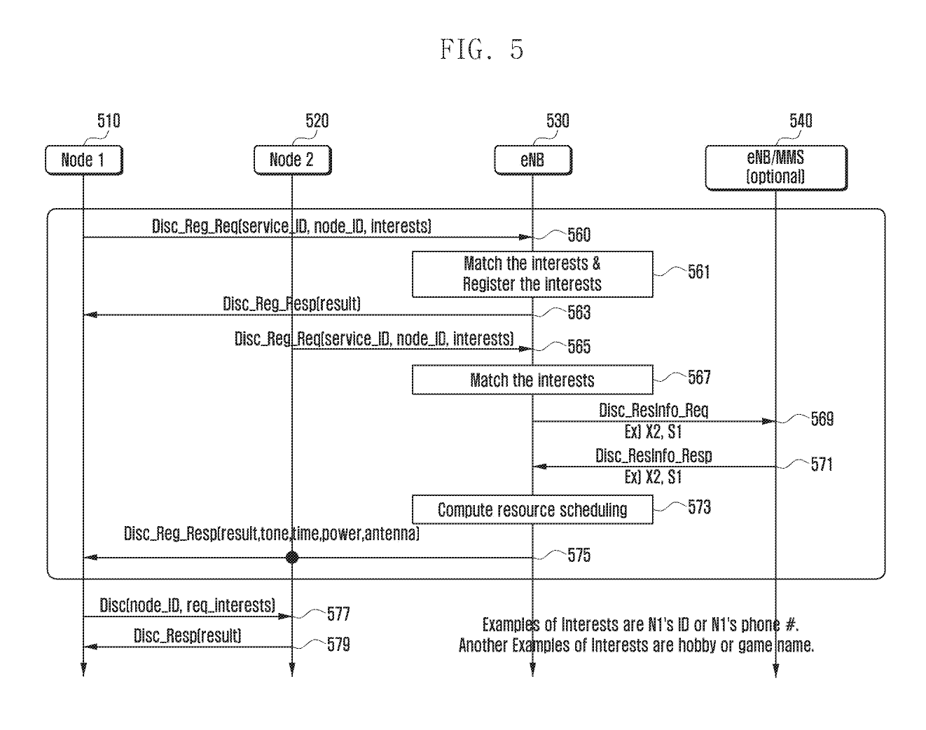

FIG. 5 is a signal flow diagram illustrating a discovery procedure according to another embodiment of the present invention.

The embodiment of FIG. 5 is directed to the case where the D2D discovery service is of a social activity such as friend-finding, friend-making, and gaming

Referring to FIG. 5, the first UE 510 may send the serving eNB 530 a discovery registration request (Disc_Reg_Req) message at step 560. At this time, the Disc_Reg_Req message transmitted by the first UE 510 may include a service identifier (service_ID) of the discovery service and interest information of the first UE 510. At this time, the discovery registration request (Disc_Reg_Req) message transmitted from the first UE 510 to the serving eNB 530 may further include its identity information (i.e., its node ID).

The interest information may include, but without being limited to, the identifier (ID), phone number, or address information of the second UE 520 which the first UE 510 is searching for. For example, if the first UE 510 is interested in use of the discovery service for a game, it may transmit the interest information including the identity information of the corresponding game to the serving eNB 530.

According to an embodiment, valid time information may be transmitted along with the interest information. In order to indicate that it will give up the service if it fails to find the second UE 520 in 3 minutes, the first UE 510 may send the serving eNB 530 the valid time set to 3 minutes.

The serving eNB 530 may compare the interest information received from other UEs at the previous step and the interest information received from the first UE 510 to determine at step 561 whether the interest information matches. If there is any match in the interest information, the serving eNB 530 may send the first UE 510 a response message. Otherwise if there is no match in the interest information, the serving eNB 530 may register the discovery request information (i.e., interest) of the first UE 510. Then the serving eNB 530 may send the first UE 510 a discovery registration response (Disc_Reg_Resp) message at step 563. According to an embodiment, the Disc_Reg_Resp message may include the information on the matching result.

After predetermined time has passed, the second UE 520 may send the serving eNB 530 a Discovery Registration Request (Disc_Reg_Req) message at step 565. At this time, the Disc_Reg_Req message transmitted by the second UE 520 may include the service identifier (service_ID) of the discovery service, the interest information of the second UE, and the identity information of the second UE (e.g., node ID).

The serving eNB 530 may compare the interest information received from the second UE 520 at step 565 and the interest information received from the first UE 510 at step 560 to determine whether they match.

If the interest information of the first UE 510 includes the identity information of the first and second UEs and the interest information of the second UE includes the identity information of the first and second UEs, the serving eNB 530 may perform authentication procedure with a higher level network entity.

That is, the serving eNB 530 may send the MME or the higher level gateway (e.g., S-GW) a discovery resource information registration request (Disc_ResInfo_Req) message at step 569. The MME 540 may perform authentication on the information received by the eNB 530, location registration, NAS key setup, and D2D key acquisition operations.

Although not shown, the MME 540 may perform discovery resource information registration on the received information upon receipt of the Disc_ResInfo_Req message as at step 463. That is, the MME 540 may perform the received information authentication, location-registration, NAS key setup, and D2D key acquisition operations.

After registering the discovery resource information, the MME 540 may send the serving eNB 530 a discovery resource information registration response (Disc_ResInfo_Resp) message at step 571.

According to an embodiment, the Disc_ResInfo_Req and Disc_ResInfo_Resp messages may be transmitted over, but without being limited to, an X2 or S1 interface.

Then, although not shown, the serving eNB 530 may receive neighbor eNB resource allocation information from a neighbor eNB. According to an embodiment, the serving eNB 530 may send the neighbor eNB a response message.

The serving eNB 530 may allocate resources in the tone, time, power, and antenna domains on the basis of the service_IDs received from the first and second UEs 510 and 520 and neighbor eNB resource allocation information at step 573. The detailed description thereof has been made above and thus omitted herein.

Then the serving eNB 530 may send the first and second UEs 510 and 520 a discovery registration response (Disc_Reg_Resp) message at step 575. At this time, the Disc_Reg_Resp message may include the information on the allocated discovery resource. That is, the serving eNB 530 may send the first and second UEs 510 and 520 the information on the discovery resources allocated in the tone, time, power, and antenna domains. According to an embodiment, the discovery resource allocation information may be transmitted over, but without being limited to, PDCCH.

The first and second UEs 510 and 520 may perform discovery operations at steps 577 and 579. For example, if the second UE 520 transmits the discovery signal including its identity and interest information, the first UE 510 may transmit a response message upon receipt of and in response to the discovery signal.

The second UE 520 may stop transmitting the discovery signal upon receipt of the response signal from the first UE 510. According to an embodiment, the second UE 520 may stop transmitting the discovery signal in predetermined time after the receipt of the response signal.

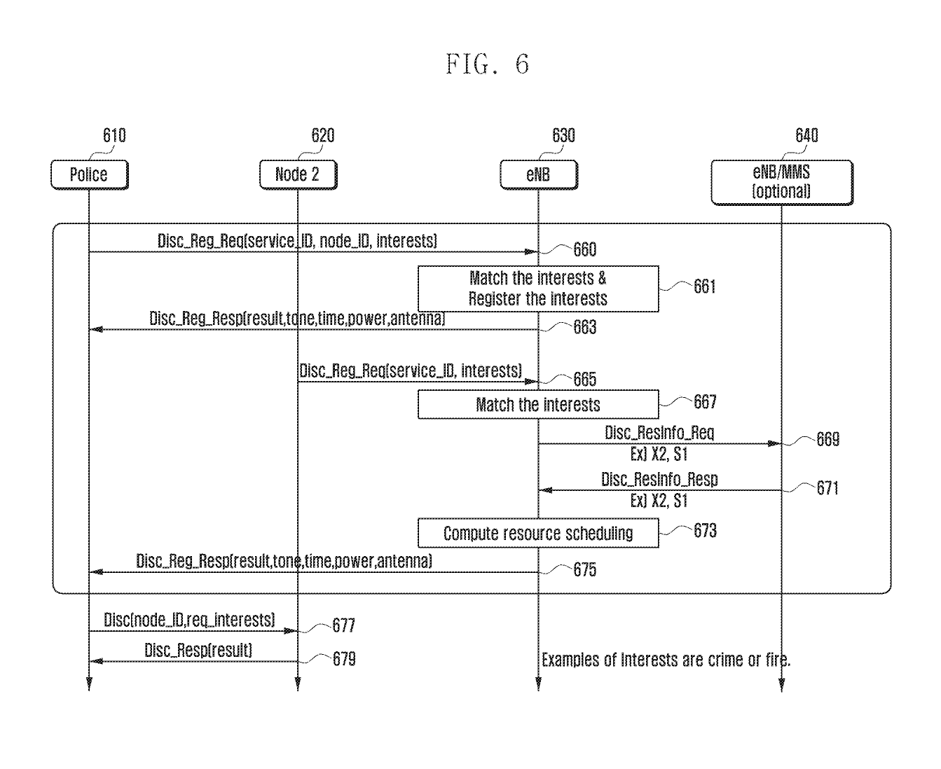

FIG. 6 is a signal flow diagram illustrating a discovery procedure according to another embodiment of the present invention.

The embodiment of FIG. 6 is directed to the case where the D2D discovery service is of public safety.

Referring to FIG. 6, the first UE (e.g., a public office) 610 may send the serving eNB 630 a discovery registration request (Disc_Reg_Req) message at step 660. At this time, the Disc_Reg_Req message transmitted by the first UE 610 may include a service identifier (service_ID) of the discovery service and interest information of the first UE 610. At this time, the discovery registration request (Disc_Reg_Req) message transmitted from the first UE 610 to the serving eNB 630 may further include its identity information (i.e., its node ID).

The interest information may include, but without being limited to, type of safety and target area. For example, the interest information transmitted to the serving eNB 630 may include criminal or fire outbreak information.

The serving eNB 630 may register the request from the first UE 610 at step 661. Although not shown, the serving eNB 530 may receive the neighbor eNB resource allocation information from the neighbor eNB. According to an embodiment, the serving eNB 630 may send the neighbor eNB a response message.

The serving eNB may allocate resources in the tone, time, power, and antenna domains on the basis of the service_ID received from the first UE 510 and the neighbor eNB resource allocation information. The detailed description thereof has been made above and thus omitted herein.

Then the serving eNB 630 may send the first UE 610 a discovery registration response (Disc_Reg_Resp) message including a result of the discovery registration request of the first UE 610 at step 663. At this time, the Disc_Reg_Resp message may include the information on the allocated discovery resource. That is, the serving eNB 630 may send the first UE 610 the information on the discovery resources allocated in the tone, time, power, and antenna domains.

The second UE 620 which is interested in the corresponding service may send the serving eNB 630 a discovery registration request (Dsc_Reg_Req) message at step 665. At this time, the Disc_Reg_Resp message transmitted from the second UE 620 to the serving eNB 630 may include the service identifier (service_ID) of the corresponding discovery service and the interest information and identity information (e.g., node ID) of the second UE.

The eNB determines whether the interest information registered by the first UE 610 and the interest information requested by the second UE 620 match at step 667 and, if so, performs network authentication procedure.

That is, the serving eNB 530 may send the MME or a higher level gateway (e.g., S-GW) 640 a discovery resource information registration request (Disc_ResInfo_Req) message at step 669. The MME 640 may perform authentication on the information received by the serving eNB 530, location registration, NAS key setup, and D2D key acquisition operations.

Then, although not shown, the MME 640 may perform discovery resource information registration on the received information upon receipt of the Disc_ResInfo_Req message as at step 463. That is, the MME 640 may perform the received information authentication, location-registration, NAS key setup, and D2D key acquisition operations.

After registering the discovery resource information, the MME 640 may send the serving eNB 630 a discovery resource information registration response (Disc_ResInfo_Resp) message at step 671.

According to an embodiment, the Disc_ResInfo_Req and Disc_ResInfo_Resp messages may be transmitted over, but without being limited to, an X2 or S1 interface.

Then, although not shown, the serving eNB 630 may receive neighbor eNB resource allocation information from a neighbor eNB. According to an embodiment, the serving eNB 630 may send the neighbor eNB a response message.

The serving eNB 630 may allocate resources in the tone, time, power, and antenna domains on the basis of the service_IDs received from the first and second UEs 610 and 620 and neighbor eNB resource allocation information at step 673. The detailed description thereof has been made above and thus omitted herein.

Then the serving eNB 630 may send the first and second UEs 610 and 620 a discovery registration response (Disc_Reg_Resp) message at step 675. At this time, the Disc_Reg_Resp message may include the information on the allocated discovery resource. That is, the serving eNB 630 may send the first and second UEs 610 and 620 the information on the discovery resources allocated in the tone, time, power, and antenna domains. According to an embodiment, the discovery resource allocation information may be transmitted over, but without being limited to, PDCCH.

The first and second UEs 610 and 620 may perform discovery operations at steps 677 and 679. For example, the second UE 620 which is in an urgent situation may transmit the discovery signal to the first UE (i.e., the public office) 610 based on the allocated discovery resource information and receive a response signal in reply to the discovery signal.

The detailed description of the service type-based D2D discovery operation has been made above.

Descriptions are made hereinafter of the configurations of the UE and eNB according to an embodiment of the present invention.

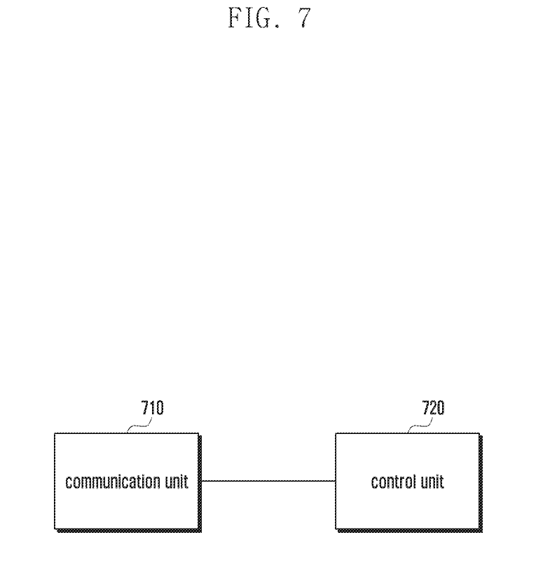

FIG. 7 is a block diagram illustrating a configuration of the UE according to an embodiment of the present invention.

Referring to FIG. 7, the control unit 720 controls the UE to perform one of the operations of the above described embodiments. For example, the control unit 720 may control to transmit to the eNB a D2D communication registration request message including the D2D communication service identity information and interest information, receive a D2D communication registration response message including D2D communication resource information according to the D2D communication service identity information, and transmit a D2D communication signal using the allocated D2D communication resources.

The communication unit 610 transmits/receives signals according to the operation of one of the above described embodiments. For example, the communication unit 610 may transmit to the eNB a D2D communication registration request message including the D2D communication service identity information and interest information.

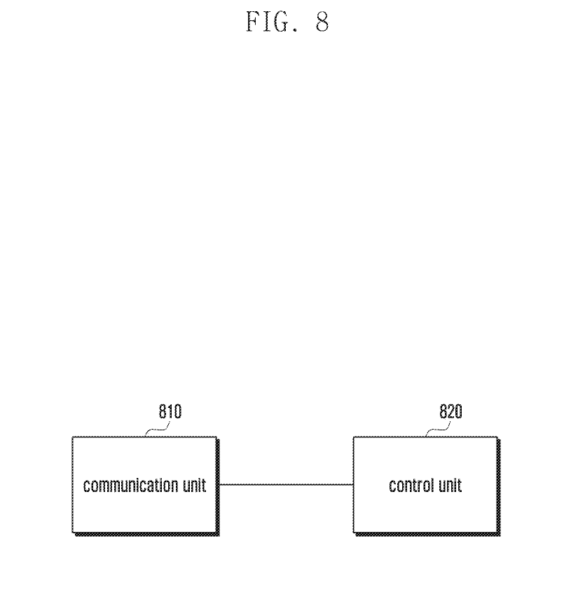

FIG. 8 is a block diagram illustrating a configuration of the eNB according to an embodiment of the present invention.

Referring to FIG. 8, the control unit 820 controls the eNB to perform one of the operations of the above described embodiments. For example, the control unit 820 may control to receive a D2D communication registration request message including D2D communication service identity information and interest information from the UE, allocate D2D communication resources according to the D2D communication service identity information, and transmit to the UE a D2D communication registration response message including the allocated D2D communication resource information.

The communication unit 810 transmits/receives signals according to the operation of one of the above described embodiments. For example, the communication unit 810 may receive a discover registration request message including the D2D communication service identity information and interest information from the UE.

The specification and drawings are to be regarded in an illustrative rather than a restrictive sense in order to help understand the present invention. It is obvious to those skilled in the art that various modifications and changes can be made thereto without departing from the broader spirit and scope of the invention.

Although preferred embodiments of the invention have been described using specific terms, the specification and drawings are to be regarded in an illustrative rather than a restrictive sense in order to help understand the present invention. It is obvious to those skilled in the art that various modifications and changes can be made thereto without departing from the broader spirit and scope of the invention.

1. A device-to-device communication method of a terminal, the method comprising:
transmitting a device-to-device communication registration request message including device-to-device communication service identity information and interest information to a base station;
receiving a device-to-device communication registration response message including allocated device-to-device communication resource information from the base station according to the device-to-device communication service identity information; and
transmitting a device-to-device communication signal using allocated device-to-device communication resources.

2. The method of claim 1, wherein the device-to-device communication service is a discovery service, and the device-to-device communication service identity information is determined based on at least one of discovery service enabled distance, energy saving mode availability, energy saving degree of the energy saving mode, discovery specification openness (valid member), discovery end condition (valid time), application identity information, and interest information.

3. The method of claim 1, wherein transmitting the device-to-device communication registration request message comprises:
determining device-to-device communication class based on the device-to-device communication identity information; and
transmitting the device-to-device communication registration request message including the device-to-device communication class and the interest information to the base station.

4. The method of claim 1, wherein the allocated device-to-device communication resource information comprises at least one of a number and positions of tones, power value, a number and positions of antennas, and a number and positions of time slots.

5. The method of claim 2, further comprising stopping transmitting the discovery signal when a response message is received from a receiving terminal which received the discovery signal.

6. A communication method of a base station, the method comprising:
receiving a device-to-device communication registration request message including device-to-device communication service identity information and interest information from a terminal;
allocating device-to-device communication resources according to the device-to-device communication service identity information; and
transmitting a device-to-device communication registration response message including allocated device-to-device communication resource information to the terminal

7. The method of claim 6, wherein allocating the device-to-device communication resources comprises:
receiving neighbor base station resource allocation information from a neighbor base station (eNB) or a higher level network entity; and
allocating the device-to-device communication resources according to the neighbor base station resource allocation information and the device-to-device communication identity information.

8. The method of claim 6, wherein the device-to-device communication service is a discovery service, and the device-to-device communication service identity information is determined based on at least one of discovery service enabled distance, energy saving mode availability, energy saving degree of the energy saving mode, discovery specification openness (valid member), discovery end condition (valid time), application identity information, and interest information.

9. The method of claim 6, wherein allocating the device-to-device communication resources comprises:
determining a device-to-device communication class based on the device-to-device communication service identity information;
determining a target QoS value according to the device-to-device communication class; and
allocating the device-to-device communication resources based on the target QoS value.

10. The method of claim 6, wherein the allocated device-to-device communication resource information comprises at least one of a number and positions of tones, power value, a number and positions of antennas, and a number and positions of time slots.

11. A terminal supporting device-to-device communication, the terminal comprising:
a communication unit which performs device-to-device communication with another terminal and a base station; and
a control unit which controls transmitting a device-to-device communication registration request message including device-to-device communication service identity information and interest information to a base station, receiving a device-to-device communication registration response message including allocated device-to-device communication resource information from the base station according to the device-to-device communication service identity information, and transmitting a device-to-device communication signal using allocated device-to-device communication resources.

12. The terminal of claim 11, wherein the device-to-device communication service is a discovery service, and the device-to-device communication service identity information is determined based on at least one of discovery service enabled distance, energy saving mode availability, energy saving degree of the energy saving mode, discovery specification openness (valid member), discovery end condition (valid time), application identity information, and interest information.

13. The terminal of claim 11, wherein the control unit determines device-to-device communication class based on the device-to-device communication identity information and controls transmitting the device-to-device communication registration request message including the device-to-device communication class and the interest information to the base station.

14. The terminal of claim 11, wherein the allocated device-to-device communication resource information comprises at least one of a number and positions of tones, power value, a number and positions of antennas, and a number and positions of time slots.

15. The terminal of claim 12, wherein the control unit controls stopping transmitting the discovery signal when a response message is received from a receiving terminal which received the discovery signal.

16. A base station comprising:
a communication unit which communicates with a terminal and another network entity; and
a control unit which controls receiving a device-to-device communication registration request message including device-to-device communication service identity information and interest information from a terminal, allocating device-to-device communication resources according to the device-to-device communication service identity information, and transmitting a device-to-device communication registration response message including allocated device-to-device communication resource information to the terminal.

17. The base station of claim 16, wherein the control unit controls receiving neighbor base station resource allocation information from a neighbor base station (eNB) or a higher level network entity and allocating the device-to-device communication resources according to the neighbor base station resource allocation information and the device-to-device communication identity information.

18. The base station of claim 16, wherein the device-to-device communication service is a discovery service, and the device-to-device communication service identity information is determined based on at least one of discovery service enabled distance, energy saving mode availability, energy saving degree of the energy saving mode, discovery specification openness (valid member), discovery end condition (valid time), application identity information, and interest information.

19. The base station of claim 16, wherein the control unit determines a device-to-device communication class based on the device-to-device communication service identity information and a target QoS value according to the device-to-device communication class and controls allocating the device-to-device communication resource based on the target QoS value.

20. The base station of claim 16, wherein the allocated device-to-device communication resource information comprises at least one of a number and positions of tones, power value, a number and positions of antennas, and a number and positions of time slots.
